(19) United States
(12) Patent Application Publication
(10) Pub. No.: US 2020/0284343 A1
(43) Pub. Date: Sep. 10, 2020

(54) PISTON HAVING TWO CENTER BORES WITH DIFFERENT SIZES

(71) Applicant: Mahle International GmbH, Stuttgart (DE)

(72) Inventor: Jochen Kortas, Murr (DE)

(21) Appl. No.: 16/763,975

(22) PCT Filed: Nov. 5, 2018
(86) PCT No.: PCT/EP2018/080173

§ 371 Date: May 13, 2020

(30) Foreign Application Priority Data
Nov. 14, 2017 (DE) 102017220286.6

(51) Int. Cl. F16J 1/18; F16J 1/16; F04B 39/00

(52) U.S. Cl. CPC F16J 1/18; F04B 39/0005; F16J 1/16

(57) ABSTRACT

A piston may include a first center bore and a second center bore configured to receive a piston pin. The first center bore and the second center bore may have different diameters. An axis of the first center bore may extend parallel to an axis of the second center bore.

### CROSS-REFERENCE TO RELATED APPLICATIONS

This application claims priority to International Patent Application No. PCT/EP2018/080173, filed on Nov. 5, 2018, and German Patent Application No. DE 10 2017 220 286.6, filed on Nov. 14, 2017, the contents of both of which are hereby incorporated by reference in their entirety.

### TECHNICAL FIELD

The present invention relates to a piston. The invention also relates to a piston pin for such a piston together with an oil-free compressor having such a piston.

### BACKGROUND

Oil-free compressors have gained an ever-increasing market share in recent years and manage without any lubrication whatsoever. Usually, however, they do not have the same performance data as oil-lubricated compressors. Oil-free compressors afford a whole series of advantages; they are, for example, low on maintenance. In an oil-lubricated compressor, moreover, an oil change is due at regular intervals, which is cost-intensive and something that is eliminated in the case of an oil-free compressor. A compressor which dispenses with oil completely has yet another great advantage: oil does not get into the compressed air, so that it is particularly suited to painting operations and leads to less contamination of the air-ducting parts. Moreover, the regular oil change is eliminated. Also, in the case of air brakes, lubricating oil cannot get into the environment.

One disadvantage with an oil-free compressor, however, is that in the long rung, due to the absence of oil, increased wear can occur at a connection between a connecting rod and a piston as a piston pin rotates.

This has hitherto been avoided in that the piston pin has been fastened through the piston head by means of screws, thereby preventing any rotation. This is disadvantageous, since to do this a hole has to be bored in the piston and screws have to be provided. Drilling a hole in the piston and providing the screws needed for screw-fastening the piston pin to the piston is costly and takes more effort to assemble. It is also possible to connect the piston pin and the piston together by means of a press fit, thereby largely preventing the piston pin from rotating relative to the piston. This is disadvantageous, however, since press fits allow only a small margin with regard to tolerances, which again results in high costs and takes a great deal of time to produce. Furthermore, dismantling the piston for maintenance is rendered considerably more difficult. For example, it would not be possible to change just the piston ring; the piston and the pin would have to be completely replaced.

### SUMMARY

The present invention therefore addresses the problem of specifying an improved or at least alternative embodiment for a piston which overcomes the disadvantages known from the prior art.

According to the invention this object is achieved by the subject matter of the independent claim(s). Advantageous embodiments form the subject of the dependent claim(s).

The present invention is based on the general idea of preventing an unwanted rotation of the piston pin in the center bores through a special geometric shape of a piston pin and associated center bores/piston-pin bosses. The piston according to the invention comprises a first center bore and a second center bore for receiving the piston pin, the two center bores having different diameters. Here, according to the invention, an axis of the first center bore runs parallel to an axis of the second center bore. When fitting the piston pin in the piston, the piston pin is first introduced into the first center bore and then through a connecting-rod eye into the second center bore of the piston. The different diameters and different axes of the two center bores make it possible to prevent a rotation of the piston pin in the center bores solely by virtue if the geometric shaping. This is advantageous, since it is thereby possible to secure the piston pin against torsion without having to screw the piston pin to the piston, which in assembling saves both time and costs. Without departing from the scope of the present invention, the piston pin may be arranged with a slight play in the first and second center bore following assembly, or the piston pin may still be capable of slight rotation in the first and second center bore after assembling. Since the geometric shaping of the piston pin and the associated center bores largely or entirely prevents a rotation of the piston pin in the piston, the wear to the compressor can be considerably reduced when used in an oil-free compressor.

In one possible embodiment the piston pin in the fitted state is arranged to form a positive interlock in the first and second center bore. This is advantageous, since the positively interlocking arrangement of the piston pin in the first and second center bore together with the axial offset defines an unambiguous fitting position, which enables even an unpracticed operative to fit the piston pin correctly, since the center bores together with the piston pin form a so-called poka-yoke system, which allows only one fitting position.

In a further possible embodiment, the piston pin has at least two different outside diameters. The two outside diameters of the piston pin are here complementary to the (inside) diameters of the first and second center bore of the piston. Since the two center bores have a different diameter, the piston pin suitably has at least two different outside diameters, since this ensures that the piston pin can be introduced into the center bores and after assembly is arranged to form a positive interlock in the two center bores. Since the axis of the first center bore moreover runs parallel to the axis of the second center bore, it is only possible to introduce the piston pin in a single position.

In a further advantageous embodiment, the axis of the first center bore is offset by an offset V parallel to the axis of the second center bore in the stroke direction of the piston. The axes are accordingly offset in the stroke direction. The mass distribution in the stroke direction is more symmetrical than with an offset in a horizontal direction. Moreover, it is simpler in geometric terms to achieve the necessary boss reinforcement for the eccentrically offset center bore.

In a further development of the invention the axis of the first center bore may be offset by an offset V parallel to the axis of the second center bore transversely to the stroke direction of the piston. The axes are accordingly offset transversely to the stroke direction. The offset transversely to the stroke direction produces an unequal inertial force distribution. This can have a positive influence on the contact reversal of the piston in the cylinder from the major to the minor thrust face, thus reducing the noise excitation

The axis of the first center bore may be suitably offset by an offset V parallel to the axis of the second center bore in the stroke direction of the piston and transversely thereto. The direction of the offset V may accordingly lie in the stroke direction and transversely to the stroke direction, or may also assume any other desired angle in between. If the piston has a first center bore and a second center bore, the axes of which run without any offset relative to one another, this may possibly allow a rotation of a piston pin arranged in the first and second center bore if the first and second center bore each form a circular opening. In order to largely or entirely prevent a rotation of the piston pin in the first and second center bore, it would be necessary for the first and second center bore to have a non-circular geometric shape. If the axis of the first center bore is offset by an offset V parallel to the axis of the second center bore in the stroke direction of the piston and transversely thereto, however, this is advantageous, since it is thereby ensured that the first and second center bore can have a circular geometric shape whilst nevertheless virtually or entirely preventing a rotation of the piston pin.

Furthermore, the offset V of the axes of the first and second center bore may suitably lie between 0.2 mm and 3 mm. If the axes of the first and second center bore are offset by an offset V between 0.2 mm and 3 mm, this is sufficient to ensure that the piston pin can be rotated only slightly in the first and second center bore of the piston, if at all. If the offset V corresponds to approximately to 0.2 mm, the piston pin is arranged with a slight play in the first and second center bore and can accordingly be rotated slightly before the torsion leads to a jamming of the piston pin in the piston. If the offset V corresponds to approximately 3 mm, the piston pin is arranged almost without any play whatsoever in the first and second center bore, so that a rotation of the piston pin in the piston is virtually impossible. In other words: the smaller the offset V, the more readily the piston pin can rotate in the piston, the greater the offset V, the less the piston pin is able to rotate in the piston before the rotation of the piston pin leads to jamming of the piston pin in the piston.

The present invention is further based on the general idea of providing a matching piston pin for the piston previously described which has a first outside diameter on a first cylindrical longitudinal end area and a second outside diameter on a second cylindrical longitudinal end area, the diameters being of different sizes and arranged offset by an offset V with respect to their cylinder axes. The first outside diameter and the second outside diameter here are complementary to the diameter of the first and second center bore. The offset V of the cylinder axes of the piston pin and the offset V of the axes of the first and second center bore together mean that the piston pin is arranged, secured against torsion, in the piston without further fasteners, and wear occurring in the operation of an oil-free compressor can thereby at least be reduced.

In a further advantageous embodiment of the piston pin according to the invention the cylinder axes of the two longitudinal end areas of the piston pin have an offset of between 0.2 mm and 3 mm relative to one another. It is necessary, depending on what offset V the axes of the first and second center bore have relative to one another, that the cylinder axes of the piston pin be offset by a complementary offset V, in order to ensure that the piston pin can be introduced into the piston.

Further important features and advantages of the invention emerge from the dependent claims, from the drawings and from the associated description of the figures referring to the drawings.

It goes without saying that the features specified above and yet to be explained below can be used not only in the particular combination described but also in other combinations or singly, without departing from the scope of the present invention.

Preferred exemplary embodiments of the invention are represented in the drawings and are explained in more detail in the following description, the same reference numerals referring to identical or similar or functionally equivalent components.

### BRIEF DESCRIPTION OF THE DRAWINGS

The figures schematically show:

FIG. 1 shows a sectional representation of a piston according to the invention,

FIG. 2 shows a sectional representation of the piston according to the invention transversely to the stroke direction,

FIG. 3 shows a front view of a piston pin according to the invention,

FIG. 4 shows a longitudinal sectional representation of the piston pin according to the invention.

### DETAILED DESCRIPTION

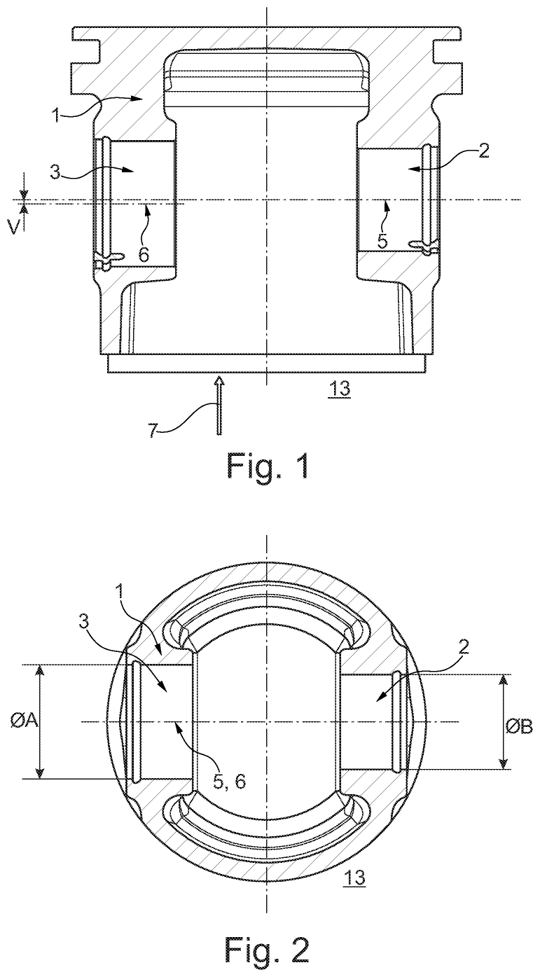

According to FIGS. 1 and 2 a piston 1 comprises a first center bore 2 and a second center bore 3 for receiving a piston pin 4. The first center bore 2 and the second center bore 3 have different diameters A, B. An axis 5 of the first center bore 2 runs parallel to an axis 6 of the second center bore 3. A stroke direction 7 of the piston 1 is represented by the direction of the arrow in FIG. 1. As is illustrated in FIG. 1, the axis 5 is offset by an offset V relative to the axis 6 in the stroke direction 7. Without departing from the scope of the present invention, the axis 5 may be offset by an offset V relative to the axis 6 transversely to the stroke direction 7. It is equally possible for the axis 5 to be offset by an offset V in the stroke direction 7 and transversely to the stroke direction 7. Since the axis 5 and the axis 6 in FIGS. 1 and 2 are offset only in the stroke direction 7, the offset V can be represented only in FIG. 1, since the axis 5 and the axis 6 lie parallel one on top of the other and for this reason can be represented only as one line in FIG. 2. In FIG. 2 an offset V can be represented only if the axis 5 and the axis 6 have an offset V transversely to the stroke direction.

In the assembled state, the piston pin 4, not represented in FIGS. 1 and 2, is arranged to form a positive interlock in the first center bore 2 and in the second center bore 3.

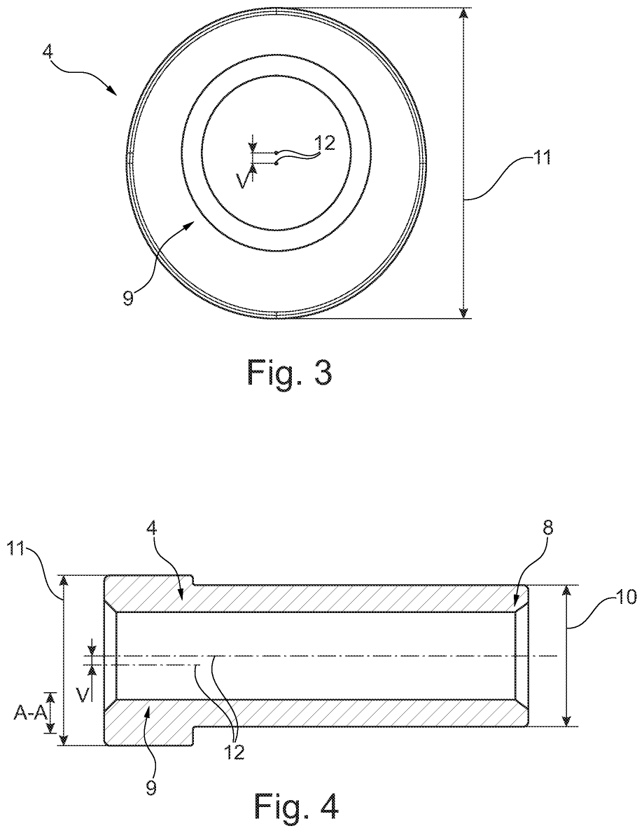

According to FIGS. 3 and 4 the piston pin 4 has a first outside diameter 10 on a first cylindrical longitudinal end area 8 and a second outside diameter 11 on a second cylindrical longitudinal end area 9. The first outside diameter 10 and the second outside diameter 11 are of different sizes. As is illustrated in FIGS. 3 and 4, the cylinder axes 12 are arranged offset relative to one another by an offset V. Without departing from the scope of the present invention, the cylinder axes 12 may be offset relative to one another in a manner different from that represented in FIGS. 3 and 4. The offset of the cylinder axes 12 (cf. FIGS. 3 and 4) here must be complementary to the relative offset V of the axis 5 of the first center bore 2 and the axis 6 of the second center bore 3 (cf. FIGS. 1 and 2.). The cylinder axes 12 in FIG. 3 run into the viewing plane and are accordingly represented as points.

The piston according to the invention 1 and the piston pin 4 according to the invention are in particular used in an oil-free compressor 13 not represented in FIGS. 1 to 4. The piston pin 4 serves to connect a connecting rod to the piston 1. The connecting rod is introduced into the piston 1 and the piston pin 4 is then likewise introduced into the piston 1, in such a way that the connecting rod is fixed in the piston 1 by the piston pin 4 and the piston pin 4 is supported by positive interlock in the first center bore 2 and in the second center bore 3.

The offset V serves to prevent a rotation of the piston pin 4 in the piston 1 by virtue of a geometric shaping, so that the wearing of the piston pin 4 and the piston 1 during operation of the compressor 13 is at least reduced. A rotation of the piston pin 4 in the piston 1 leads to a gentle jamming of the piston pin 4 in the piston 1. Without departing from the scope of the present invention, the piston pin 4 may be supported with a slight play in the piston 1.

The first outside diameter 10, the second outside diameter 11, the diameter B of the first center bore 2 and the diameter A of the second center bore 3 are of different sizes, the diameter B of the first center bore 2 being formed to complement the first outside diameter 10 and the diameter A of the second center bore 3 to complement the second outside diameter 11. This prevents an incorrect fitting of the piston pin 4, since it is possible to fit the piston pin 4 into the piston 1 in only one direction, in such a way that the first cylindrical longitudinal end area 8 is arranged in the first center bore 2 complementing the first outside diameter 10 and the second cylindrical longitudinal end area 9 is arranged in the second center bore 3 complementing the second outside diameter 11.

1. A piston, comprising:
a first center bore and a second center bore configured to receive a piston pin, wherein:
the first center bore and the second center bore have different diameters; and
an axis of the first center bore extends parallel to an axis of the second center bore.

2. The piston as claimed in claim 1, further comprising the piston pin, wherein, in a fitted state, the piston pin is arranged to form a positive interlock in the first center bore and the second center bore.

3. The piston as claimed in claim 2, wherein the piston pin has at least two different outside diameters.

4. The piston as claimed in claim 1, wherein the axis of the first center bore is offset from the axis of the second center bore in a stroke direction.

5. The piston as claimed in claim 1, wherein the axis of the first center bore is offset from the axis of the second center bore in a direction extending transversely to a stroke direction.

6. The piston as claimed in claim 1, wherein the axis of the first center bore is offset from the axis of the second center bore in a stroke direction and in a direction extending transversely to the stroke direction.

7. The piston as claimed in claim 1, wherein the axis of the first center bore and the axis of the second center bore are offset from one another by an offset distance of 0.2 mm to 3 mm.

8. A piston pin for the piston as claimed in claim 1, comprising:
a first cylindrical longitudinal end area having a first outside diameter and a first cylinder axis;
a second cylindrical longitudinal end area having a second outside diameter and a second cylinder axis;
wherein the first outside diameter and the second outside diameter are different from one another; and
wherein the first cylinder axis and the second cylinder axis are offset from one another.

9. The piston pin as claimed in claim 8, wherein the first cylinder axis and the second cylinder axis are offset from one another by an offset distance of 0.2 mm to 3 mm.

10. An oil-free compressor, comprising a piston as claimed in claim 1.

11. The oil-free compressor as claimed in claim 10, further comprising a piston pin including:
a first cylindrical longitudinal end area having a first outside diameter; and
a second cylindrical longitudinal end area having a second outside diameter.

12. The oil-free compressor as claimed in claim 11, wherein:
the first outside diameter of the piston pin substantially corresponds to a diameter of the first center bore; and
the second outside diameter of the piston pin substantially corresponds to a diameter of the second center bore.

13. The oil-free compressor as claimed in claim 10, further comprising a piston pin including:
a first cylindrical longitudinal end area having a first cylinder axis;
a second cylindrical longitudinal end area having a second cylinder axis; and
the first cylinder axis and the second cylinder axis are offset from one another.

14. The oil-free compressor as claimed in claim 13, wherein the axis of the first center bore is offset from the axis of the second center bore.

15. The oil-free compressor as claimed in claim 14, wherein an offset between the axis of the first center bore and the axis of the second center bore is complimentary to an offset between the first cylinder axis and the second cylinder axis.

16. The oil-free compressor as claimed in claim 14, wherein:
the axis of the first center bore is offset from the axis of the second center bore by an offset distance;
the first cylinder axis is offset from the second cylinder axis by the offset distance; and
the offset distance is 0.2 mm to 3 mm.

17. The oil-free compressor as claimed in claim 10, further comprising a piston pin including:
a first cylindrical longitudinal end area having a first outside diameter and a first cylinder axis; and
a second cylindrical longitudinal end area having a second outside diameter and a second cylinder axis;
wherein the first cylinder axis and the second cylinder axis are offset from one another; and
wherein the axis of the first center bore and the axis of the second center bore are offset from one another.

18. The oil-free compressor as claimed in claim 17, wherein:
the first outside diameter of the piston pin substantially corresponds to a diameter of the first center bore;
the second outside diameter of the piston pin substantially corresponds to a diameter of the second center bore; and
an offset between the axis of the first center bore and the axis of the second center bore is complimentary to an offset between the first cylinder axis and the second cylinder axis such that the piston pin is only insertable into the first center bore and the second center bore when the piston pin is arranged in a fitting position.

19. The oil-free compressor as claimed in claim 18, wherein the piston pin is disposed in the fitting position and is arranged within the first center bore and the second center bore forming a positive interlocking connection therewith.

20. The piston as claimed in claim 1, wherein:
the axis of the first center bore is a central longitudinal axis of the first center bore; and
the axis of the second center bore is a central longitudinal axis of the second center bore.
